(19) United States
(12) Patent Application Publication
(10) Pub. No.: US 2026/0110118 A1
(43) Pub. Date: Apr. 23, 2026

(54) METHOD FOR WEAVING WITH SELVAGE

(71) Applicant: SAFRAN, PARIS (FR)

(72) Inventor: Marc-Antoine André Louis COLOT, MOISSY-CRAMAYEL (FR)

(21) Appl. No.: 19/476,052

(22) PCT Filed: Apr. 16, 2024
(86) PCT No.: PCT/FR2024/050503

§ 371 Date: Oct. 16, 2025

(30) Foreign Application Priority Data
Apr. 19, 2023 (FR) FR2303887

(51) Int. Cl. D03D 5/00; B29C 70/24; D03D 25/00

(52) U.S. Cl. CPC D03D 5/00; B29C 70/24; D03D 25/005; D10B 2505/02

(57) ABSTRACT

A method for three-dimensionally weaving a texture between a plurality of warp yarns extending along a longitudinal direction and a plurality of columns of weft yarns, the weft yarns extending along a transverse direction, the texture including a central part extending along the transverse direction between a first selvedge and a second selvedge, wherein at least one of the selvedge includes at least one primary weaving plane perpendicular to the transverse direction in which the weft yarns derived from the same column of weft yarns of the central part of the texture are group-interlinked, the weft yarns of the same group being aligned along the longitudinal direction.

### TECHNICAL FIELD

The present invention relates to the weaving of woven textures using a Jacquard-type weaving loom, and particularly to the weaving of woven textures having significant thicknesses.

### Prior Art

A Jacquard-type weaving loom is conventionally used to make textures by three-dimensional weaving between a plurality of layers of warp yarns and a plurality of layers of weft yarns. Such a weaving loom is in particular described in document FR 3 074 195 A1.

As is known, the weaving loom is equipped with a Jacquard mechanism. The loom also comprises a harness including control yarns or heddles, each control yarn being connected at one end to a control element of the Jacquard mechanism.

Each control yarn comprises an eyelet through which a warp yarn passes. The control yarns and their associated eyelet are able to move vertically. The control yarns allow lifting some warp yarns and thus creating a shed, that is to say an opening between the lower and upper webs of warp yarns. Said shed, thus opened, allows the introduction of a weft yarn by means of a rapier. The rapier comprises a rod that can be provided at its end with a gripper that grips a weft yarn from a bobbin and places it through the opening between the webs of warp yarns created by the shed, the weft yarn being cut using cutting tools after it has been positioned in the shed. The weaving loom also comprises a reed whose beat-up allows packing the weft yarn inserted into the shed.

However, it has been found that the inserted weft yarns were not properly blocked by the warp yarns at the edges of the texture during the weaving. However, if the weft yarns are not properly blocked during their insertion, subsequent weft yarns may not be placed in the correct location and may therefore not interact properly with the rapier, the cutting tools and any yarn guiding systems. For example, a misplaced weft yarn may not be gripped by the rapier. Thus, the weaving must be interrupted frequently to correct the anomalies.

### Disclosure of the Invention

In order to ensure a blocking of the inserted weft yarns, it has been proposed to use selvedge warp yarns on the edges of the texture that allow blocking the inserted weft yarns during the weaving.

However, in order to ensure a satisfactory blocking of the weft yarns by the selvedge warp yarns, the interlinking between the weft yarns and the selvedge warp yarns was very dense. Thus, this generated selvedge areas with a much higher yarn density than the central part of the texture, which could cause unwanted ripples or distortions of the selvedge areas or lead to jamming effects during the beat-up of the reed. Furthermore, this gradually generated misalignment during the weaving on the weaving loom between the selvedge areas and the central part of the texture, with the denser selvedge areas not advancing as quickly on the weaving loom as the central part of the less dense in yarns.

The more the fibrous texture comprised layers of yarns, the greater the problems of the weft yarn placement and density difference between the selvedge areas and the central part of the texture.

The present invention aims to overcome the aforementioned drawbacks by proposing a texture selvedge adapted to the three-dimensional weaving. To this end, the invention proposes a method for three-dimensionally weaving a texture between a plurality of warp yarns extending along a longitudinal direction and a plurality of columns of weft yarns, said weft yarns extending along a transverse direction, the texture extending along the transverse direction between a first selvedge and a second selvedge, the texture comprising a central part present between the selvedges, the method being characterized in that at least one of the first or second selvedge comprises at least one primary weaving plane perpendicular to the transverse direction in which the weft yarns derived from the same column of weft yarns of the central part of the texture are group-interlinked, the weft yarns of the same group being aligned along the longitudinal direction.

Such a weaving method allows ensuring, thanks to the selvedge(s), a suitable blocking of the inserted weft yarns, thus reducing the risks of misalignment of the weft yarns to be inserted and consequently reducing anomalies and interruptions in the weaving.

By interlinking the weft yarns in groups rather than individually in the selvedge(s) of the texture, the density of yarns in said selvedge(s) is also reduced. Thus, this limits the phenomena of ripples in the selvedge(s), the risks of jamming during the beat-of of the reed and the gradual misalignment between the selvedge(s) and the central part of the texture during the weaving. Furthermore, the alignment of the weft yarns of the same group along the longitudinal direction further allows reducing the misalignment between the selvedges and the central part of the texture during the weaving on the weaving loom.

This method also allows eliminating the need for templets, that is to say tapered rollers comprising pins configured to grip the yarns of the selvedges, which allows, by their rotation, forcing the alignment of the selvedges with the central part during the weaving. Indeed, the templets can damage the selvedge yarns with their pins, and only grip the surface yarns, which can cause a shift between the surface yarns of the selvedges pulled by the templets and the core yarns which are not stressed by said templets.

According to one particular embodiment of the invention, the groups of weft yarns in the primary weaving plane bring together a number of weft yarns comprised between two and seven, and preferably between two and five.

According to one particular embodiment of the invention, the primary weaving plane comprises at least one portion in which the number of warp yarns in the first or second selvedge interlinking the weft yarns derived from the same column of weft yarns of the central part of the texture is half the number of weft yarns in said column, namely less than the number of layers of weft yarns.

Thus, the selvedge(s) comprise a reduced number of warp yarns, which allows for a limited yarn density.

According to another particular embodiment of the invention, the warp yarns of at least the first or second selvedge interlink the weft yarns in a satin-type or plain-type weave in the primary weaving plane.

Satin-type or plain-type weaves allow for very strong interlinking of the weft yarns, said weft yarns thus being very satisfactorily blocked during the weaving of the texture.

The warp yarns of at least the first or second selvedge may also interlink the weft yarns in a twill-type weave in the primary weaving plane.

The choice of the weave may depend on the number of weft yarns in the group, the count of the weft yarns and the weft yarn density. Thus, the higher the weft yarn density, the more a weave requiring a low warp yarn density will be preferred, that is to say a weave with a low warp interlinking frequency by integrating warp floats.

When the warp yarns of at least the first or second selvedge interlink the weft yarns in a satin-type or plain-type weave in the primary weaving plane, there are two possible embodiments. According to a first embodiment, the weft yarns are interlinked so as to form a superposition of strata each having a two-dimensional weaving of the satin or plain type in the primary weaving plane, the different strata not being interlinked to each other in the primary weaving plane. According to another embodiment, the weft yarns are interlinked so as to form a superposition of strata each having a two-dimensional weaving of the satin or plain type in the primary weaving plane, the different strata being interlinked to each other by local interlinking in the primary weaving plane.

According to another particular embodiment of the invention, the warp yarns of at least the first or second selvedge interlink the weft yarns in a three-dimensional weave in the primary weaving plane. For example, the warp yarns of at least the first or second selvedge may interlink the weft yarns in an interlock-type weave in the primary weaving plane. Various three-dimensional weaving modes are described in document WO 2006/136755.

The use of a three-dimensional weave allows further reducing the yarn density required to block the weft yarns.

According to one particular embodiment of the invention, at least the first or second selvedge further comprises at least one secondary weaving plane perpendicular to the transverse direction in which the warp yarns are disposed on either side of sets of weft yarns comprising weft yarns derived from one or more of the same columns of weft yarns of the central part of the texture.

The use of one or more secondary weaving planes complements the primary weaving plane(s). Indeed, the primary weaving planes allow a satisfactory blocking of the weft yarns along the transverse direction, but the groups of weft yarns may not be correctly blocked relative to each other along the direction of thickness of the texture perpendicular to the longitudinal and transverse directions. The use of such secondary weaving planes thus allows blocking the different groups of weft yarns along the thickness direction.

According to one particular embodiment of the invention, the number of warp yarns in the secondary weaving plane is two.

Thus, the warp yarn density in a secondary weaving plane is low, and allows for an overall reduction in the yarn density of the selvedge.

According to one particular embodiment of the invention, the weaving plane(s) of the first or second selvedge closest to the texture are secondary weaving planes.

Thus, the wefts inserted into the thickness of the fibrous texture are better contained, which avoids distortions within the central part of the texture.

According to one particular embodiment of the invention, the weaving plane(s) of the first or second selvedge furthest from the texture are secondary weaving planes.

Thus, the end of the selvedge is well retained and compacted, and is not likely to separate in the thickness direction.

According to one particular embodiment of the invention, the first or second selvedge comprises no more than four consecutive primary weaving planes along the transverse direction.

According to one particular embodiment of the invention in which the central part of the texture has a reduction in the number of weft yarns per column of weft yarns along the longitudinal direction, the number of warp yarns in the weaving planes of the first or second selvedge remains constant along the longitudinal direction.

By maintaining a constant number of warp yarns along the longitudinal direction in the weaving planes of the selvedge, that is to say by not achieving any exit of selvedge warp yarns, the presence of free and non-interlinked selvedge warp yarns is avoided, which would therefore be likely to break and cause interruptions in the weaving. Thus, all the warp yarns used in the selvedge are well attached and unlikely to create anomalies or defects in the weaving of the selvedges.

According to one particular embodiment of the invention, the texture is intended to form a fibrous reinforcement for a composite material part of an aeronautical engine.

The invention further proposes a method for manufacturing a composite material part comprising:
weaving a texture by implementing the weaving method described above,
shaping the woven texture obtained to obtain a preform of the part to be manufactured,
densifying the preform by a matrix so as to obtain the composite material part whose reinforcement is formed by the preform.

### BRIEF DESCRIPTION OF THE DRAWINGS

FIG. 1 is a schematic perspective view of a Jacquard-type weaving loom for making a woven texture.

FIG. 2 illustrates a weaving plane belonging to the central part of the woven texture of FIG. 1.

FIG. 3 illustrates a primary weaving plane belonging to a selvedge of the woven texture of FIG. 1.

FIG. 4 illustrates a secondary weaving plane belonging to a selvedge of the woven texture of FIG. 1.

FIG. 5 illustrates a weaving plane belonging to the central part of a woven texture comprising a reduction in the number of weft yarns along the longitudinal direction.

FIG. 6 illustrates a primary weaving plane belonging to a selvedge of the woven texture of FIG. 5.

### DESCRIPTION OF THE EMBODIMENTS

The invention generally applies to the three-dimensional weaving methods for making woven textures between layers of warp yarns and layers of weft yarns. By “three-dimensional weaving” it is meant here a weaving mode by which at least some of the warp yarns interlink weft yarns over several weft layers. It is considered that a woven texture made by three-dimensional weaving may comprise another type of weaving on its surface, for example two-dimensional weaving, in order to improve its surface condition. Furthermore, it is considered that a woven texture made by three-dimensional weaving may comprise another type of weaving at the level of its selvedges, in order to ensure the blocking of the weft yarns at the edge of the texture.

The woven texture may for example have a three-dimensional weave of the interlock, multi-twill or multi-satin type. Different three-dimensional weaving modes that can be used to form the woven texture are described in document WO 2006/136755.

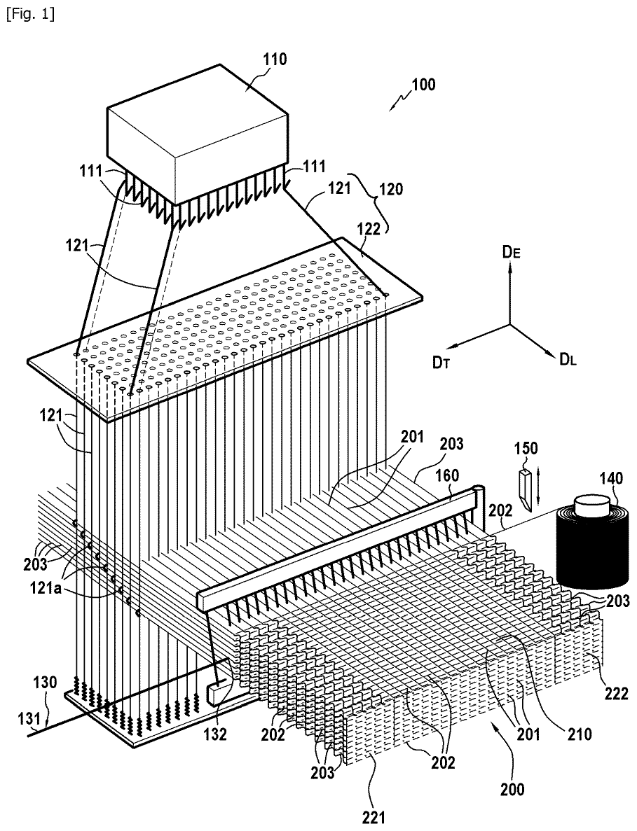

FIG. 1 illustrates a weaving loom 100 for carrying out the weaving method of the invention. The weaving loom 100 according to the invention allows obtaining a woven texture 200 by weaving a plurality of layers of warp yarns 201 and 203 with a plurality of layers of weft yarns 202. The warp yarns 201 and 203 extend along a longitudinal direction D_{L} and the weft yarns 202 extend along a transverse direction D_{T}, the transverse direction D_{T} being perpendicular to the longitudinal direction D_{L}.

The woven texture 200 thus extends in length along the longitudinal direction D_{L}, in width along the transverse direction D_{T} and in thickness along a thickness direction D_{E} perpendicular to the longitudinal and transverse directions D_{T} and D_{L}.

The weaving loom is equipped with a Jacquard mechanism 110 supported by a superstructure not represented in FIG. 1. The loom 100 also comprises a harness 120 including control yarns or heddles 121, each control yarn 121 being connected at one end to a control element 111 of the Jacquard mechanism 110. In the example illustrated in FIG. 1, each control yarn 121 is connected at one end to a control hook 111 of the Jacquard mechanism 110 and at the other end to a return spring 112 fixed to the frame 113 of the weaving loom 100. The control yarns 121 extend along the thickness direction DE. The harness 120 may also comprise a tying-up board 122.

Each control yarn 121 comprises an eyelet 121a through which a warp yarn 201, 203 passes. Each warp yarn 201 or 203 of the loom 100 passes through an eyelet 121a of the harness 120. The warp yarns 201 or 203 are organized at the level of the harness 120 of the weaving loom 100 in a plurality of horizontal layers and vertical columns which are manipulated by the weaving loom 100 to allow the insertion of weft yarns 202 in the weaving pattern(s) programmed in the weaving loom 100. The weft yarns 202 are inserted between the warp yarns 201 or 203 in columns extending along the thickness direction D_{E}. In order to allow the introduction of each column of weft yarns 202 during the weaving of the texture 200, a warp yarn 201, 203 take-up system (not represented in FIG. 1) is associated with the weaving loom 100. This system, placed downstream of the weaving loom 100, has the role of retaining all the warp yarns 201, 203 together in a clamping device and of allowing the warp yarns 102, 203 to advance by a determined distance along the longitudinal direction D_{L} after the insertion of each weft column 202.

The terms “upstream” and “downstream” are defined here according to the direction of advance of the warp yarns 201, 203 in the weaving loom 100, that is to say in the weaving direction, along the longitudinal direction D_{L}.

The control yarns 121 and their associated eyelet 121a are able to move along the thickness direction D_{E}. In FIG. 1, all the control yarns 121 are in a neutral position in which no traction is exerted by the Jacquard mechanism 110. In this configuration, no weft yarn 202 is inserted and all the warp yarns 201 extend parallel to the longitudinal direction D_{L}.

During the insertion of a weft yarn 202, part of the control yarns 121 is subjected to traction forces exerted by the control hooks 111. In this configuration, the control yarns allow raising or lowering warp yarns, so as to separate an upper web of warp yarns from a lower web of warp yarns by an opening, called shed.

The weaving loom 100 also comprises a rapier 130, present downstream of the control yarns 121. The rapier 130 is composed of a rod 131, a first end of which is connected to an actuation system (not represented in FIG. 1) making it possible to drive the rod 131 with a back-and-forth movement along the transverse direction D_{T}. The path of the rapier 130 may be fixed relative to the frame 113 of the weaving loom 100. The other end of the rod 131 is provided with a gripper 132 which, after having passed through the shed during the outward path of the rod 131, can grip a weft yarn 202 stored on a bobbin 140 to unwind it in the shed during the return path of the rod 131. The weft yarn 202 thus placed inside the shed is then cut in the vicinity of the bobbin 140 by a cutting tooling 150 and released at its other end by the gripper 132. A comb 160 present upstream of the rapier 130 and downstream of the harness 120 in its rest position is then folded down in order to pack the weft yarn(s) 202 introduced into the shed.

The weaving loom 100 may further comprise a guide device comprising at least one upper jaw and one lower jaw configured to be positioned in contact with the woven texture 200 and on either side of said texture 200 along the thickness direction D_{E}, said guide device being present downstream of the plurality of control yarns 121 and of the rapier 130, the guide device being able to move along the thickness direction D_{E} so as to move the woven texture 200 upwards or downwards. Such a guide device allows adjusting the position along the thickness direction D_{E} of the woven texture 200, so as to facilitate the insertion of the weft yarns 202.

The weaving method according to the invention allows making the woven texture 200 extending along the transverse direction D_{T} between a first selvedge 221 and a second selvedge 222. The first selvedge 221 and the second selvedge 222 extend along the longitudinal direction D_{L} along the woven texture 200. Preferably, the first selvedge 221 and the second selvedge 222 extend along the longitudinal direction D_{L} over the entire length of the woven texture 200. The woven texture 200 comprises a central part 210 which extends between the first selvedge 221 and the second selvedge 222. Preferably, the central part 210 of the woven texture 200 extends from the first selvage 221 to the second selvage 222.

The guide device as described above allows adjusting the positioning of the central part 210 of the texture 200 along the thickness direction D_{E} during the insertion of the weft yarns 202. The guide device as described above also allows adjusting the positioning of the selvedges 221 and 222 along the thickness direction D_{E} during the insertion of the weft yarns 202. The guide device preferably allows adjusting the position of the selvedge(s) 221 and 222 along the thickness direction D_{E} independently of the adjustment of the position of the central part 210 along the thickness direction D_{E}. Thus, the selvedge(s) 221 and 222 may be retained by upper and lower jaws of the guide device that are distinct from the upper and lower jaws of the guide device retaining the central part 210.

Correct positioning of the woven texture 200 along the thickness direction D_{E}, that is to say correct positioning of both the central part 210 and the selvedge(s) 211 and 222 along the thickness direction D_{E}, is particularly important when the central part 210 of the fibrous texture has portions in which the number of weft yarns per column of weft yarns is greater than or equal to 6, in order to ensure correct insertion of the weft yarns by the rapier 130.

The central part 210 of the woven texture 200 is made by three-dimensional weaving between a plurality of central warp yarns 201 and the plurality of weft yarns 202.

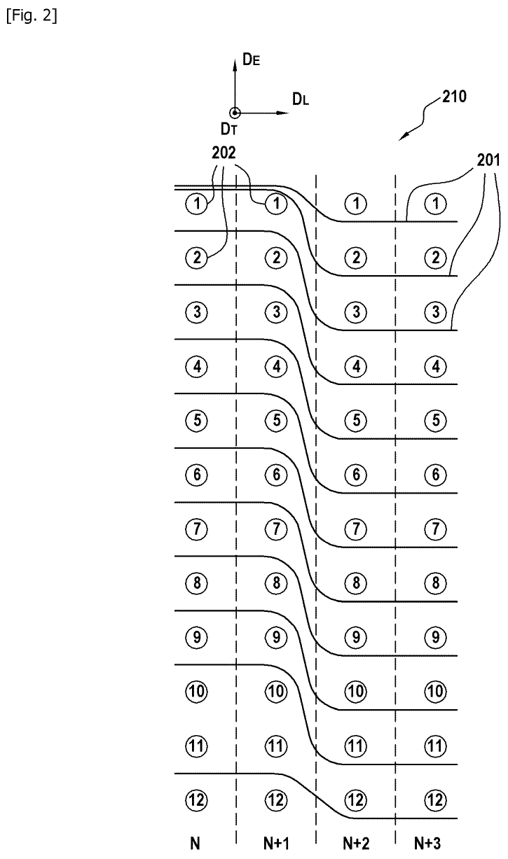

FIG. 2 illustrates a portion of one exemplary weaving plane of the central part 210 of the woven texture 200 perpendicular to the transverse direction D_{T}. Particularly, FIG. 2 illustrates four columns N, N+1, N+2 and N+3 of weft yarns 202 of said exemplary weaving plane of the central part 210.

In the example illustrated in FIG. 2, each column N, N+1, N+2 and N+3 of weft yarns 202 of the central part 210 comprises twelve weft yarns 202. It is of course not beyond the framework of the invention if one or more columns of weft yarns of the central part comprise more than twelve weft yarns. It is also not beyond the framework of the invention if one or more columns of weft yarns of the central part comprise more than twelve weft yarns.

The columns N, N+1, N+2 and N+3 of weft yarns 202 in the central part 210 of the woven texture 200 are woven three-dimensionally with the plurality of central warp yarns 201. In the example illustrated in FIG. 2, the central warp yarns 201 are woven with the weft yarns 202 in a multi-twill weave in the central part 210. It is of course not outside the framework of the invention if the central warp yarns 201 are woven with the weft yarns 202 in another three-dimensional weave in the central part 210.

The first and second selvedges 221 and 222 are made by weaving between a plurality of selvedge warp yarns 203 and the plurality of weft yarns 202. The weft yarns 202 in the first or second selvedge 221 or 222 are woven with the plurality of selvedge warp yarns 203. The selvedge warp yarns 203 are interlinked with the weft yarns 202 in the selvedges 221 or 222 according to successive weaving planes perpendicular to the transverse direction D_{T}.

Preferably, the warp yarns 203 present in the selvedge(s) 221 or 222 have a smaller diameter than the diameter of the warp yarns 201 present in the central part 210 of the texture 200, in order to better block the weft yarns 202 in the selvedge(s) 221 and 222. Preferably, the warp yarns 203 present in the selvedge(s) 221 or 222 have an average diameter between 6 times and 10 times smaller than the average diameter of the warp yarns 201 of the central part 210.

The warp yarns 203 present in the selvedge(s) 221 or 222 may be made of a different material from the warp yarns 201 of the central part 210. For example, the warp yarns 203 present in the selvedge(s) 221 or 222 may be made of polyester, for example with a count of 220 tex.

At least part of the weaving planes according to which the selvedge warp yarns 203 and the weft yarns 202 are woven into the first or second selvedge 121 or 122 are primary weaving planes. The primary weaving planes are weaving planes in which the weft yarns 202 derived from the same column of weft yarns 202 of the central part 210 are group-interlinked by the selvedge warp yarns 203, the weft yarns 202 of the same group being aligned along the longitudinal direction D_{L}.

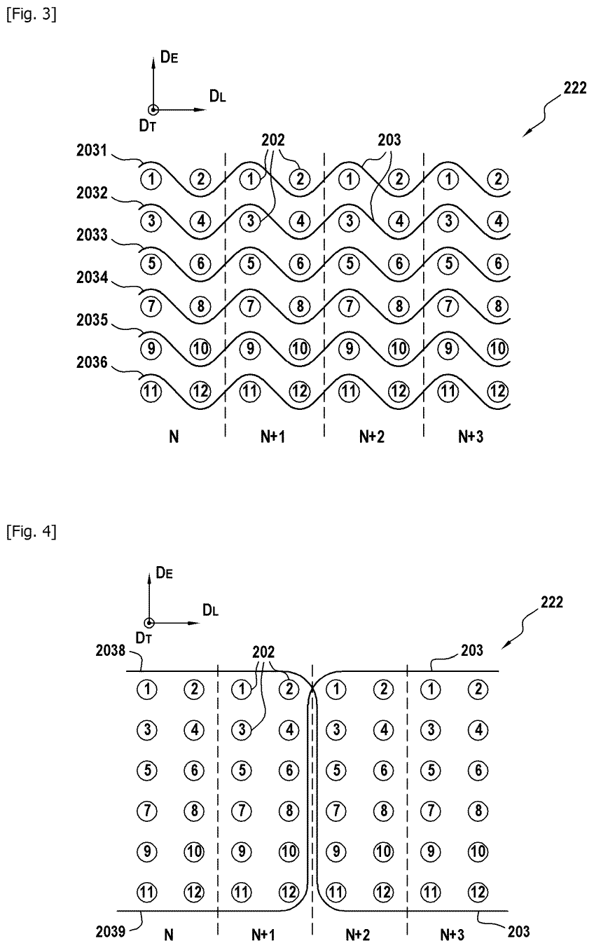

In the example illustrated in FIGS. 3 and 4, the weft yarns 202 derived from the same column of weft yarns 202 of the central part 210 are interlinked in pairs by the selvedge warp yarns 203, the weft yarns 202 of the same pair being aligned along the longitudinal direction D_{L}. Groups comprising only two weft yarns 202 are thus made. It is of course not outside the framework of the invention if the groups comprise more than two weft yarns. For example, the weft yarns derived from the same column of weft yarns of the central part may be interlinked in trios by the selvedge warp yarns 203, the weft yarns of the same trio being aligned along the longitudinal direction D_{L}.

The groups may comprise only two to seven weft yarns, or even only two to five weft yarns. Preferably, the groups within a primary weaving plane bring together the same number of weft yarns. Preferably, the groups within a secondary weaving plane bring together the same number of weft yarns.

A group of weft yarns according to the invention brings together at least two weft yarns. By “group-interlinked” is meant that all the weft yarns 202 not present on the surface derived from the same column of weft yarns 202 of the central part 210 are group-interlinked. The weft yarns 202 present on the surface of the selvedge 221 or 222 may be interlinked alone, or in a smaller number. Thus, preferably, in a primary weaving plane, there are at most two weft yarns 202 for each set of weft yarns 202 derived from the same column of weft yarns 202 which are not group-interlinked.

A single selvedge 221 or 222 may comprise a single primary weaving plane, or may comprise several primary weaving planes. Preferably, a single selvedge 221 or 222 comprises at least two primary weaving planes, in order to ensure a satisfactory blocking of the weft yarns. A single selvedge 221 or 222 may comprise different primary weaving planes, that is to say the weft yarns 202 derived from a single column of weft yarns 202 of the central part 210 are interlinked according to different groups from one primary weaving plane to another.

Preferably, in a primary weaving plane, the selvedge warp yarns 203 interlink the weft yarns 202 along a satin-type or plain-type weave. Indeed, the satin-type or plain-type weaves allow strong interlinking of the weft yarns 202, which ensures their blocking at the level of the selvedges 221 or 222. Preferably, if the weft yarns 202 have a large diameter, for example a diameter greater than or equal to 2 mm, the selvedge warp yarns 203 will interlink the weft yarns 202 in the primary weaving plane(s) in a satin-type weave. On the contrary, if the weft yarns 202 have a small diameter, for example a diameter less than 2 mm, the selvedge warp yarns 203 will preferably interlink the weft yarns 202 in the primary weaving plane(s) in a plain-type weave. Generally, if the density of weft yarns 202 in the central part 210 of the texture 200 is high, that is to say if the density is greater than 4 yarns per cm in each weaving plane, the selvedge warp yarns 203 will interlink the weft yarns 202 in the primary weaving plane(s) in a satin-type weave. On the contrary, if the density of weft yarns 202 in the central part 210 of the texture 200 is low, that is to say if the density is less than or equal to 4 yarns per cm in each weaving plane, the selvedge warp yarns 203 will interlink the weft yarns 202 in the primary weaving plane(s) in a plain-type weave. More generally, the choice of the weave takes into account the density of weft yarns, the count of the weft yarns and the number of weft yarns to be blocked.

FIG. 3 illustrates a portion of one exemplary primary weaving plane of the first or second selvedge 221 or 222 of the woven texture 200 perpendicular to the transverse direction D_{T}. The weft yarns 202 illustrated in FIG. 3 are the weft yarns 202 of the columns N, N+1, N+2 and N+3 of weft yarns 202 of the central part 210 represented in FIG. 2.

In the example illustrated in FIG. 3, the selvedge warp yarns 2031, 2032, 2033, 2034, 2035 and 2036 interlink in pairs the weft yarns 202 derived from the same column N, N+1, N+2 and N+3 of weft yarns 202 of the central part 210. For example, the first selvedge warp yarn 2031 interlinks the first weft yarn and the second weft yarn of the first column N of weft yarns 202 of the central part 210, the second selvedge warp yarn 2032 interlinks the third weft yarn and the fourth weft yarn of the first column N of weft yarns 202 of the central part 210, the third selvedge warp yarn 2033 interlinks the fifth weft yarn and the sixth weft yarn of the first column N of weft yarns 202 of the central part 210, and so on. For example, the first selvedge warp yarn 2031 interlinks the first weft yarn and the second weft yarn of the first column N of weft yarns 202 of the central part 210, interlinks the first weft yarn and the second weft yarn of the second column N+1 of weft yarns 202 of the central part 210, interlinks the first weft yarn and the second weft yarn of the third column N+2 of weft yarns 202 of the central part 210, and interlinks the first weft yarn and the second weft yarn of the fourth column N+3 of weft yarns 202 of the central part 210.

The number of selvedge warp yarns 203 in each primary weaving plane is preferably smaller than the number of central warp yarns 201 in each weaving plane perpendicular to the transverse direction D_{T} of the central part 210 of the texture 200. Preferably, a first weaving plane comprises at least a portion in which the number of selvedge warp yarns 203 interlinking weft yarns 202 derived from the same column of weft yarns 202 of the central part 210 is half the number of weft yarns 202 of said column. In the case where the number of weft yarns 202 derived from the same column of weft yarns 202 of the central part 210 is odd, a number “half the number of weft yarns” designates the rounding up to the higher integer of half of said number of weft yarns.

Furthermore, preferably, at least part of the weaving planes in which the selvedge warp yarns 203 and the weft yarns 202 are woven in the first or second selvedge 121 or 122 are secondary weaving planes. The secondary weaving planes are weaving planes in which the selvedge warp yarns 203 are disposed on either side of sets of weft yarns 202 comprising weft yarns 202 derived from one or more of the same columns of weft yarns 202 of the central part 210 of the texture 200. Thus, in the secondary weaving plane(s), the selvedge warp yarns 203 are present on the upper or lower surface of the selvedge 221 or 222 at the level of each weft column derived from the central part 210 of the texture 200. Consequently, the secondary weaving plane(s) comprise at least two selvedge warp yarns 203. Preferably, the secondary weaving plane(s) comprise only two selvedge warp yarns 203, in order to ensure the retention of the weft yarns 202 while limiting the density of yarns in the selvedge 221 or 222.

The secondary weaving plane(s) thus allow interlinking together all the layers of weft yarns 202 so that they are well retained along the thickness direction D_{E}. The secondary weaving plane(s) complement the primary weaving planes to ensure the blocking of the weft yarns 202 along the thickness direction D_{E} in the selvedges 221 or 222 of the texture 200. Indeed, the primary weaving planes allow blocking the weft yarns 202 along the transverse direction D_{T} by interlinking them in groups, but said groups are poorly interlinked together. The use of secondary weaving planes in which selvedge warp yarns 203 are disposed on either side of all the groups of weft yarns 202 derived from the same column of weft yarns 202 allows tightening said groups with each other.

FIG. 4 illustrates a portion of one exemplary secondary weaving plane of the first or second selvage 221 or 222 of the woven texture 200 perpendicular to the transverse direction D_{T}. The weft yarns 202 illustrated in FIG. 4 are the weft yarns 202 of the columns N, N+1, N+2 and N+3 of weft yarns 202 of the central part 210 represented in FIG. 2 and FIG. 3.

In the example illustrated in FIG. 4, the selvedge warp yarns 2038 and 2039 are disposed on either side of a set of weft yarns 202 comprising weft yarns 202 derived from the first and second columns N and N+1 of weft yarns 202 of the central part 210 of the texture 200 and of a set of weft yarns 202 comprising weft yarns 202 derived from the third and fourth columns N+2 and N+3 of weft yarns 202 of the central part 210 of the texture 200. Thus, the selvedge warp yarn 2038 is present on the upper surface of the selvedge 221 or 222 at the level of the first and second columns N and N+1 of weft yarns derived from the central part 210 and present on the lower surface of the selvedge 221 or 222 at the level of the third and fourth columns N+2 and N+3 of weft yarns derived from the central part 210. Conversely, the selvedge warp yarn 2039 is present on the lower surface of the selvedge 221 or 222 at the level of the first and second columns N and N+1 of weft yarns derived from the central part 210 and present on the upper surface of the selvedge 221 or 222 at the level of the third and fourth columns N+2 and N+3 of weft yarns derived from the central part 210.

Preferably, the weaving plane(s) of the selvedge 221 or 222 closest to the central part 210 are one or more secondary weaving planes. Thus, the wefts inserted into the thickness of the fibrous texture are better contained, which allows avoiding distortions within the central part of the texture.

Preferably, the weaving plane(s) of the selvedge 221 or 222 furthest from the central part 210 are one or more secondary weaving planes. Thus, the end of the selvedge is well retained and compacted, and is not likely to separate in the thickness direction.

Preferably, the string sequence of the weaving planes along the transverse direction D_{T} in the selvedge 221 or 222 is done by alternating two consecutive secondary weaving planes with four consecutive primary weaving planes along the transverse direction D_{T}. This string sequence of the weaving planes allows a particularly satisfactory blocking of the weft yarns 202 with an optimal compromise between a blocking of the weft yarns 202 along the transverse direction D_{T} thanks to the primary weaving planes, and a bunching and a blocking of all the weft yarns 202 along the thickness direction D_{E}. Particularly, it is desired to avoid more than four primary weaving planes being consecutive along the transverse direction D_{T}. Indeed, by inserting one or more secondary weaving planes so as to avoid more than four consecutive primary weaving planes, the selvedge is better contained in the thickness direction D_{E}.

It is desirable that the number of selvedge warp yarns woven in each primary or secondary weaving plane of the selvedge(s) perpendicular to the transverse direction D_{T} is constant along the longitudinal direction D_{L}. Indeed, the removal of selvedge warp yarns as the weaving progresses in the longitudinal direction would generate free selvedge warp yarns likely to break. However, a breakage of a selvedge warp yarn can lead to anomalies in the weaving of the selvedges or even of the central part of the texture, and may require an unwanted interruption of the weaving. By maintaining a constant number of woven selvedge warp yarns along the longitudinal direction, as illustrated in FIGS. 3 and 4, it is ensured that said selvedge yarns are well attached and have a low risk of breakage.

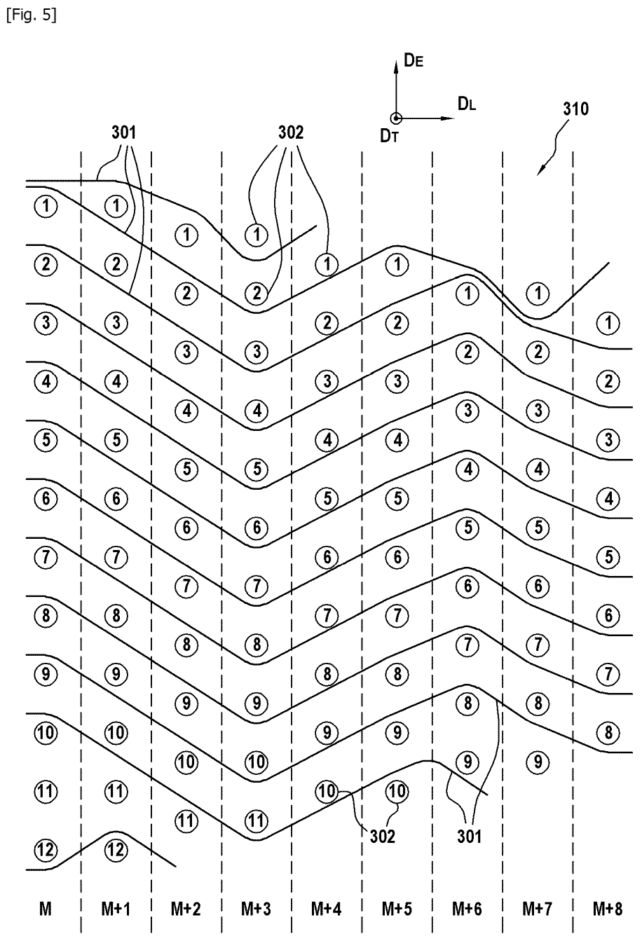

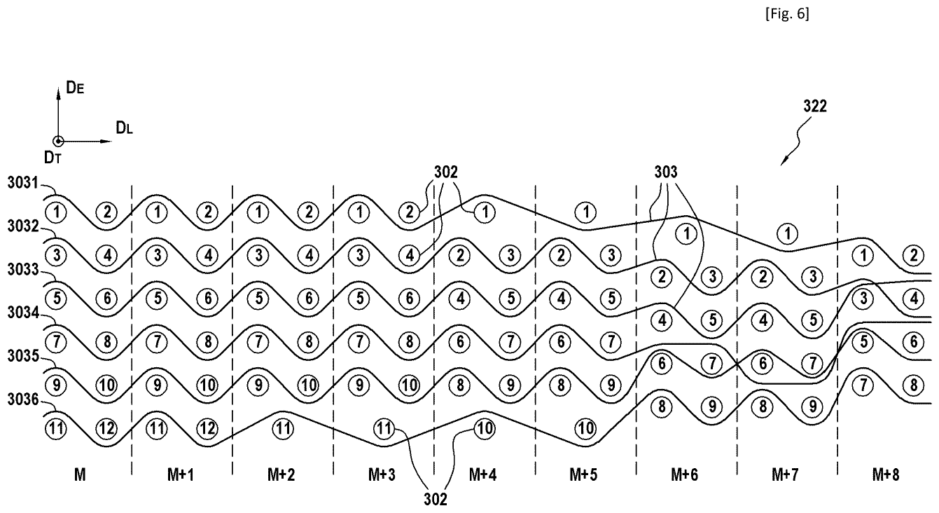

FIGS. 5 and 6 illustrate one exemplary embodiment of a woven texture comprising a thickness variation along the longitudinal direction D_{L}. The woven texture illustrated in FIGS. 5 and 6 comprises a central part 310 and one or more selvedges 310. The woven texture is made by three-dimensional weaving between a plurality of warp yarns 301 and 303 and a plurality of weft yarns 202. The woven texture illustrated in FIGS. 5 and 6 may be made using the weaving loom 100 illustrated in FIG. 1.

The central part 310 of the woven texture is made by three-dimensional weaving between a plurality of central warp yarns 301 and the plurality of weft yarns 302.

FIG. 5 illustrates a portion of one exemplary weaving plane of the central part 310 of the woven texture perpendicular to the transverse direction D_{T}. Particularly, FIG. 5 illustrates nine columns M, M+1, M+2, M+3, M+4, M+5, M+6, M+7 and M+8 of weft yarns 302 of said exemplary weaving plane of the central part 310.

In the example illustrated in FIG. 5, the first and second columns M and M+1 of weft yarns 302 of the central part 310 each comprise twelve weft yarns 202. The amount of weft yarns 202 in each column of weft yarns 202 decreases along the longitudinal direction D_{L} between the first column M of weft yarns and the ninth column M+8 of weft yarns. The ninth column M+8 of weft yarns then comprises only eight weft yarns 202 in the example illustrated in FIG. 5.

In the example illustrated in FIG. 5, the reduction in the number of weft yarns 202 along the longitudinal direction D_{L} is accompanied by a reduction in the number of central warp yarns 301, that s to say central warp yarns 301 are exited from the fibrous texture. It is of course not outside the framework of the invention if the central part 310 of the woven texture does not comprise any central warp yarn exit.

The weft yarns 302 derived from the columns M, M+1, M+2, M+3, M+4, M+5, M+6, M+7 and M+8 of weft yarns 302 of the central part 310 of the woven texture are woven three-dimensionally with the plurality of central warp yarns 301. In the example illustrated in FIG. 5, the central warp yarns 301 are woven with the weft yarns 302 in an interlock-type weave in the central part 310. It is of course not outside the framework of the invention if the central warp yarns 301 are woven with the weft yarns 302 in another three-dimensional weave in the central part 310. In order to obtain an interesting surface condition of the central part 310, a different weave can be used on the surface of the central part 310. Thus, in the example illustrated in FIG. 5, the central part 310 comprises a multi-satin type weaving on the surface.

The selvedge(s) 322 are made by weaving between a plurality of selvedge warp yarns 303 and the plurality of weft yarns 302. The selvedge warp yarns 303 are interlinked with the weft yarns 302 in the selvedge(s) 322 in successive weaving planes perpendicular to the transverse direction D_{T}.

At least part of the weaving planes in which the selvedge warp yarns 203 and the weft yarns 202 are woven in the first or second selvedge 121 or 122 are primary weaving planes as described above.

FIG. 6 illustrates a portion of one exemplary primary weave plane of the selvedge(s) 322 of the woven texture perpendicular to the transverse direction D_{T}. The weft yarns 302 illustrated in FIG. 6 are the weft yarns 302 of the columns M, M+1, M+2, M+3, M+4, M+5, M+6, M+7 and M+8 of weft yarns 302 of the central part 310 represented in FIG. 5.

In the example illustrated in FIG. 6, the selvedge warp yarns 3031, 3032, 3033, 3034, 3035, 3036 interlink in pairs the weft yarns 302 derived from the same column M, M+1, M+2, M+3, M+4, M+5, M+6, M+7 and M+8 of weft yarns 302 of the central part 310. For example, the first selvedge warp yarn 3031 interlinks the first weft yarn and the second weft yarn of the first column M of weft yarns 302 of the central part 310, the second selvedge warp yarn 3032 interlinks the third weft yarn and the fourth weft yarn of the first column M of weft yarns 302 of the central part 310, the third selvedge warp yarn 3033 interlinks the fifth weft yarn and the sixth weft yarn of the first column M of weft yarns 302 of the central part 310, and so on. For example, the first selvedge warp yarn 3031 interlinks the first weft yarn and the second weft yarn of the first column M of weft yarns 302 of the central part 310, interlinks the first weft yarn and the second weft yarn of the second column M+1 of weft yarns 302 of the central part 310, interlinks the first weft yarn and the second weft yarn of the third column M+2 of weft yarns 302 of the central part 310, and interlinks the first weft yarn and the second weft yarn of the fourth column M+3 of weft yarns 302 of the central part 310.

Preferably, as illustrated in FIG. 6, a first weaving plane comprises at least one portion in which the number of selvedge warp yarns 303 interlinking weft yarns 302 derived from the same column of weft yarns 302 of the central part 310 is half the number of weft yarns 302 of said column. In the case where the number of weft yarns 302 derived from the same column of weft yarns 302 of the central part 310 is odd, a number “half the number of weft yarns” designates the rounding up to the higher integer of half of said number of weft yarns. In the example illustrated in FIG. 6, the first weaving plane indeed comprises a portion in which the number of selvedge warp yarns 303 interlinking weft yarns 302 derived from the same column of weft yarns 302 of the central part 310 is half the number of weft yarns 302 of said column, this portion comprising the columns M, M+1, M+2 and M+3 of weft yarns 302.

Furthermore, preferably, at least part of the weaving planes in which the selvedge warp yarns 303 and the weft yarns 302 are woven into the first or second selvedge 121 or 122 are secondary weaving planes as described above.

Preferably, the number of selvedge warp yarns 303 woven into each primary or secondary weaving plane of the selvedge(s) 322 perpendicular to the transverse direction D_{T} is constant along the longitudinal direction D_{L}, even when the central part 310 has variations in thickness or a variation in the number of weft yarns. Indeed, the removal of selvedge warp yarns 303 as the weaving progresses in the longitudinal direction D_{L} would generate free selvedge warp yarns likely to break. However, a breakage in a selvedge warp yarn can lead to anomalies in the weaving of the selvages or even of the central part of the texture, and may require an undesired interruption of the weaving. By maintaining a constant number of woven selvedge warp yarns 303 along the longitudinal direction D_{L}, as illustrated in FIG. 6, it is ensured that said selvedge yarns 303 are well attached and have a low risk of breakage, even when the number of weft yarns 302 per column of weft yarns 302 of the central part 310 decreases along the longitudinal direction D_{L}.

The warp and weft yarns used in the present invention, and particularly the warp and weft yarns of the central part, may be fibers, for example carbon, glass or ceramic fibers, or a mixture of such fibers. Particularly, the woven texture can be made from fibers consisting of the following materials: silicon carbide, alumina, mullite, silica, an aluminosilicate, a borosilicate, or a mixture of several of these materials.

The woven texture can thus be intended to form the fibrous reinforcement of a composite material part, for example a ceramic-matrix composite (CMC) or organic-matrix composite (OMC) material part. The woven texture can thus be intended to form the fibrous reinforcement of a composite material part for an aeronautical engine, for example an aeronautical engine blade. Indeed, the use of organic-matrix composite (OMC) and ceramic-matrix composite (CMC) materials on aeronautical engines, as a replacement for metallic materials, contributes to optimizing aircraft performance, in particular by improving the efficiency of the turbomachine and by reducing the overall mass of the engine, thereby significantly reducing harmful emissions to the environment.

Thus, the woven texture obtained by the weaving method described above can be shaped to obtain a fibrous preform of the part to be manufactured. The shaping step can comprise compacting in order to obtain the desired fiber volume ratio in each part of the fibrous preform.

The fibrous preform may then be densified to form a matrix in the porosities of the fibrous preform, in order to obtain the composite material part. The densification of the fibrous preform may be carried out in a well-known manner by impregnating said preform with one or more matrix precursors, then by treating the impregnated preform to form the matrix. Thus, the densification may be carried out in a well-known manner by injection molding techniques, for example resin injection molding techniques or Resin Transfer Molding (abbreviated RTM), suspension injection molding techniques or Slurry Transfer Molding (abbreviated STM), or by flexible membrane injection techniques. The densification or consolidation of the fibrous preform may also be carried out in a well-known manner by Chemical Vapor Infiltration (abbreviated CVI).

The selvedge(s) of the fibrous texture are preferably retained in the final part. However, it is of course not outside the framework of the invention if all or part of the selvedge(s) of the fibrous texture is removed after the weaving.

1. A method for three-dimensionally weaving a texture between a plurality of warp yarns extending along a longitudinal direction and a plurality of columns of weft yarns, said weft yarns extending along a transverse direction, the texture extending along the transverse direction between a first selvedge and a second selvedge, the texture comprising a central part present between the selvedges,
wherein at least one of the first or second selvedge comprises at least one primary weaving plane perpendicular to the transverse direction in which the weft yarns derived from the same column of weft yarns of the central part of the texture are group-interlinked, the weft yarns of the same group being aligned along the longitudinal direction.

2. The weaving method according to claim 1, wherein the groups of weft yarns in the primary weaving plane bring together a number of weft yarns comprised between two and seven.

3. The weaving method according to claim 1, wherein the primary weaving plane comprises at least one portion in which the number of warp yarns in the first or second selvedge interlinking the weft yams derived from the same column of weft yarns of the central part of the texture is half the number of weft yarns in said column.

4. The weaving method according to claim 1, wherein the warp yarns of at least the first or second selvedge interlink the weft yarns in a satin-type or plain-type weave in the primary weaving plane.

5. The weaving method according to claim 1, wherein at least the first or second selvedge further comprises at least one secondary weaving plane perpendicular to the transverse direction in which the warp yarns are disposed on either side of sets of weft yarns comprising weft yarns derived from one or more same columns of weft yarns of the central part of the texture.

6. The weaving method according to claim 5, wherein the number of warp yarns in the secondary weaving plane is two.

7. The weaving method according to claim 5, wherein the weaving plane(s) of the first or second selvedge closest to the texture are secondary weaving planes.

8. The weaving method according to claim 5, wherein the weaving plane(s) of the first or second selvedge furthest from the texture are secondary weaving planes.

9. The weaving method according to claim 1, wherein the first or second selvedge comprises no more than four consecutive primary weaving planes along the transverse direction.

10. The weaving method according to claim 1, wherein the central part of the texture has a reduction in the number of weft yarns per column of weft yarns along the longitudinal direction the number of warp yarns in the weaving planes of the first or second selvedge remaining constant along the longitudinal direction.

11. A method for manufacturing a composite material part comprising:
weaving a texture by implementing the method according to claim 1,
shaping the woven texture obtained to obtain a preform of the part to be manufactured,
densifying the preform by a matrix so as to obtain the composite material part whose reinforcement is formed by the preform.
